(19) United States
(12) Patent Application Publication
(10) Pub. No.: US 2026/0018051 A1
(43) Pub. Date: Jan. 15, 2026

(54) INFORMATION PROCESSING APPARATUS

(71) Applicant: TOYOTA JIDOSHA KABUSHIKI KAISHA, Toyota-shi (JP)

(72) Inventors: Yoshi KONDO, Kariya-shi (JP); Hiromi TONEGAWA, Kounan-shi (JP); Ryuto OHNO, Nagoya-shi (JP)

(73) Assignee: TOYOTA JIDOSHA KABUSHIKI KAISHA, Toyota-shi (JP)

(21) Appl. No.: 19/257,730

(22) Filed: Jul. 2, 2025

(30) Foreign Application Priority Data
Jul. 10, 2024 (JP) 2024-111039

(51) Int. Cl. G08G 1/01; B60W 40/068; B60W 40/103

(52) U.S. Cl. CPC G08G 1/0133; B60W 40/068; B60W 40/103; G08G 1/0112; B60W 2520/105; B60W 2540/106; B60W 2540/12; B60W 2552/15; B60W 2552/30; B60W 2556/50; B60W 2556/65

(57) ABSTRACT

An information processing apparatus calculates an actual measurement value of a wheel velocity difference of a target vehicle according to probe information including a wheel velocity of each wheel of the target vehicle in a vehicle skidability evaluation section. Furthermore, the information processing apparatus acquires a reference value for the wheel velocity difference of the target vehicle in the evaluation section. The information processing apparatus calculates an evaluation parameter using the actual measurement value and the reference value. The information processing apparatus evaluates vehicle skidability due to influence of change in road surface conditions in the evaluation section, according to the evaluation parameter. Then, the information processing apparatus outputs result information about the evaluation.

### CROSS REFERENCE TO THE RELATED APPLICATION

This application claims the benefit of Japanese Patent Application No. 2024-111039, filed on Jul. 10, 2024, which is hereby incorporated by reference herein in its entirety.

### BACKGROUND

### Technical Field

The present disclosure relates to an information processing apparatus.

### Description of the Related Art

Japanese Patent Laid-Open No. 2022-24312 discloses a driving assistance apparatus. The driving assistance apparatus disclosed Laid-Open No. 2022-24312 acquires vehicle velocity data before the ABS of a vehicle is activated and vehicle velocity data when the ABS of the vehicle is stopped. The driving assistance apparatus calculates a skidding friction coefficient based on the vehicle velocity data before the ABS is activated and the vehicle velocity data when the ABS is stopped. The driving assistance apparatus determines whether the skidding friction coefficient is equal to or below a threshold, and, when the skidding friction coefficient is equal to or below the threshold, detects that skidding due to road freezing has occurred.

Japanese Patent Laid-Open No. 2023-119792 discloses a stuck risk calculation program. In the stuck risk calculation program disclosed in Japanese Patent Laid-Open No. 2023-119792, prediction data for snow/ice conditions in a snow/ice layer on the road surface is calculated based on a heat balance model and an ice/water/air balance model for a road surface snow/ice layer, using prediction data on weather conditions and traffic conditions. Furthermore, in the stuck risk calculation program, a road surface skidding friction coefficient is decided based on the calculated snow/ice conditions prediction data. Then, in the stuck risk calculation program, the stuck risk of a vehicle on the road surface snow/ice layer is determined by linear combination among a first function with a road surface snow/ice thickness in the snow/ice conditions prediction data as a variable, a second function with a road surface snow/ice moisture content in the snow/ice conditions prediction data as a variable, and a third function with the road surface skidding friction coefficient as a variable.

Japanese Patent Laid-Open No. H11-192932 discloses a road surface condition identification apparatus. The road surface condition identification apparatus disclosed in Japanese Patent Laid-Open No. H11-192932 determines the wheel velocity of a vehicle. The road surface condition identification apparatus determines wheel acceleration/deceleration from the wheel velocity. The road surface condition identification apparatus determines a difference in the wheel acceleration/deceleration determined by wheel acceleration/deceleration calculation method. The road surface condition identification apparatus performs low-pass filtering for causing only a low-frequency component of a value obtained by performing rectification processing for the difference of the wheel acceleration/deceleration to pass. Then, the road surface condition identification apparatus compares a low-pass filtered value obtained by low-pass filtering method with a road surface condition identification threshold determined in advance from vehicle characteristics and road surface conditions to identify road surface conditions.

### SUMMARY

An object of the present disclosure is to evaluate vehicle skidability on a road in more detail.

An information processing apparatus according to a first aspect of the present disclosure includes a controller, the controller being configured to execute:
calculating an actual measurement value of a wheel velocity difference of a target vehicle according to probe information including a wheel velocity of each wheel of the target vehicle in a vehicle skidability evaluation section;
acquiring a reference value for the wheel velocity difference of the target vehicle in the evaluation section;
calculating an evaluation parameter using the actual measurement value and the reference value;
evaluating vehicle skidability due to influence of change in road surface conditions in the evaluation section, according to the parameter; and
outputting result information about the evaluation.

An information processing apparatus according to a second aspect of the present disclosure includes a controller, the controller being configured to execute:
receiving probe information in real time, the probe information including a position of a target vehicle acquired by a GPS apparatus mounted on the target vehicle and a wheel velocity of each wheel sensed by a wheel velocity sensor of the target vehicle;
referring to the probe information to determine whether the target vehicle is traveling in a vehicle skidability evaluation section or not in real time;
calculating an actual measurement value of a wheel velocity difference of the target vehicle according to the probe information when the target vehicle is traveling in the vehicle skidability evaluation section;
acquiring a reference value for the wheel velocity difference in the evaluation section;
calculating an evaluation parameter using the actual measurement value and the reference value;
evaluating vehicle skidability due to influence of change in road surface conditions in the evaluation section, according to the parameter; and
outputting result information about the evaluation to an external apparatus.

According to the present disclosure, it becomes possible to evaluate vehicle skidability on a road in more detail.

### BRIEF DESCRIPTION OF THE DRAWINGS

FIG. 1 is a diagram illustrating a schematic configuration of an evaluation system;

FIG. 2 is a block diagram schematically illustrating an example of a functional configuration of an evaluation server;

FIG. 3 is a diagram illustrating an example of a table configuration of history information held in a history information database;

FIG. 4 is a flowchart of a process executed by a controller in the evaluation server; and

FIG. 5 is a diagram illustrating an inner wheel difference when a vehicle is traveling on a curve.

### DESCRIPTION OF THE EMBODIMENT

When a vehicle is traveling on a skiddy road, the wheels easily spin. Therefore, it is assumed that, when a vehicle is traveling on a skiddy road, a wheel velocity difference becomes large. Meanwhile, there may be a case where a road is more skiddy than usual due to change in road surface conditions. Here, the change in road surface conditions occurs due to a road shape or factors other than vehicle travel conditions. Therefore, an information processing apparatus according to a first aspect of the present disclosure evaluates vehicle skidability due to influence of change in road surface conditions, using a wheel velocity difference.

A controller of the information apparatus according to the first aspect of the present disclosure calculates an actual measurement value of a wheel velocity difference of a target vehicle according to probe information. Here, the probe information is information including a wheel velocity of each wheel of the target vehicle in a vehicle skidability evaluation section. Furthermore, the controller of the information processing apparatus acquires a reference value for the wheel velocity difference of the target value in the evaluation section. The controller of the information processing apparatus calculates an evaluation parameter using the actual measurement value and the reference value. Thereby, it is possible to calculate a wheel velocity difference caused by influence of change in road surface conditions. Here, the evaluation parameter is a value that correlates with vehicle skidability due to change in road surface conditions. Therefore, the controller of the information processing apparatus evaluates the vehicle skidability due to influence of change in road surface conditions in the evaluation section, according to the evaluation parameter. Then, the controller of the information processing apparatus outputs result information about the evaluation.

As described above, the evaluation parameter is calculated by the information processing apparatus. Then, by the information processing apparatus, the vehicle skidability due to influence of change in road surface conditions in the evaluation section is evaluated according to the evaluation parameter. In this way, it becomes possible to evaluate vehicle skidability on a road in more detail.

A specific embodiment of the present disclosure will be described below based on the drawings. A hardware configuration, a module configuration, a functional configuration, and the like described in the present embodiment are not intended to limit the technical scope of the disclosure only to the configurations unless otherwise described.

### Embodiment

### Overview of System

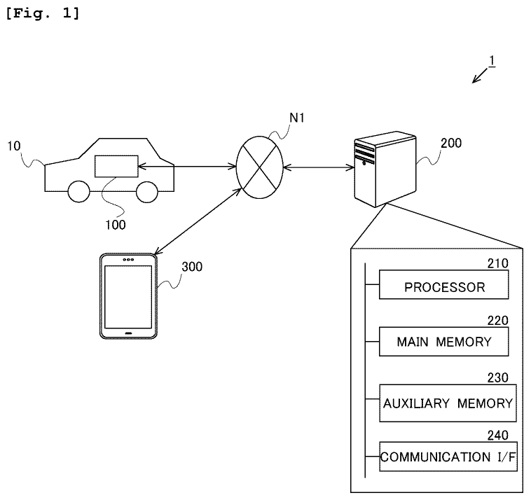

An evaluation system 1 in the present embodiment will be described based on FIG. 1 1. FIG. 1 is a diagram illustrating a schematic configuration of the evaluation system 1. The evaluation system 1 includes an onboard apparatus 100, an evaluation server 200, and a user terminal 300. In the evaluation system 1, the onboard apparatus 100, the evaluation server 200, and the user terminal 300 are mutually connected via a network N1. As the network N1, a WAN (Wide Area Network) which is a worldwide public communication network such as the Internet, or a telephone network such as a mobile phone network may be adopted.

### Onboard Apparatus

The onboard apparatus 100 is an apparatus mounted on a vehicle 10. The onboard apparatus 100 acquires probe information from an electronic control unit (ECU) of the vehicle 10 via an in-vehicle network. Here, the probe information is information including the position of the vehicle 10, an accelerator operation amount in the vehicle 10, the velocity of the vehicle 10, and the wheel velocity of each wheel of the vehicle 10.

Here, the position of the vehicle 10 is acquired by a GPS sensor in the vehicle 10. Furthermore, the accelerator operation amount in the vehicle 10 is acquired by a sensor that senses an accelerator pedal depression amount in the vehicle 10. Furthermore, the wheel velocity of each wheel of the vehicle 10 is acquired by a wheel velocity sensor in the vehicle 10 sensing the wheel velocity of each wheel. The wheel velocity sensor senses the angular velocity of each wheel as the wheel velocity. In the present embodiment, the vehicle 10 has four wheels. Therefore, the probe information includes information indicating the wheel velocities of the four wheels. Furthermore, the onboard apparatus 100 calculates the velocity of the vehicle 10 from the wheel velocity of each wheel of the vehicle 10 sensed by the wheel velocity sensor. The onboard apparatus 100 transmits the probe information to the evaluation server 200 in real time via the network N1.

### Evaluation Server

The evaluation server 200 is a server apparatus that evaluates vehicle skidability (level of ease of skidding) on a road. The evaluation server 200 receives probe information about the vehicle 10 from the onboard apparatus 100 via the network N1. The evaluation server 200 evaluates vehicle skidability in an evaluation section according to the probe information about the vehicle 10 received from the onboard apparatus 100. The evaluation server 200 outputs information indicating a result of the evaluation of vehicle skidability in the evaluation section (which may be hereinafter also referred to as “evaluation information”) to the user terminal 300 via the network N1. Details of a method for the evaluation 200 to evaluate vehicle skidability in an evaluation section according to probe information will be described later.

The evaluation server 200 includes a computer that includes a processor 210, a main memory 220, an auxiliary memory 230, and a communication interface (communication I/F) 240. The processor 210 is, for example, a central processing unit (CPU) or a digital signal processor (DSP). The main memory 220 is, for example, a random access memory (RAM). The auxiliary memory 230 is, for example, a read-only memory (ROM). The auxiliary memory 230 is, for example, a hard disk drive (HDD) or a disc recording medium like a CD-ROM, a DVD disc, or a Blu-ray disc. The auxiliary memory 230 may be a removable medium (a portable storage medium). Here, as the removable medium, for example, a USB memory or an SD card is exemplified. The communication I/F 240 is, for example, a local area network (LAN) interface board or a wireless communication circuit for wireless communication.

In the evaluation server 200, an operating system (OS), various kinds of programs, various kinds of information tables, and the like are stored in the auxiliary memory 230. Furthermore, in the evaluation server 200, by the processor 210 loading a program stored in the auxiliary memory 230 to the main memory 220 and executing the program, various kinds of functions as described below can be realized. A part or all of the functions of the evaluation server 200, however, may be realized as a hardware circuit like an ASIC or an FPGA. Note that the evaluation server 200 is not necessarily required to be realized by a single physical configuration and may be configured with a plurality of computers that work in cooperation with one another. Note that each of the onboard apparatus 100 and the user terminal 300 also includes a computer similarly to the evaluation server 200.

### User Terminal

The user terminal 300 is a terminal related to a user who receives distribution of a vehicle skidability evaluation result. Here, the terminal related to the user is, for example, a computer or a mobile information terminal used by the user. The terminal related to the user may be, for example, an onboard apparatus such as a navigation system mounted on the vehicle that the user uses. The user terminal 300 receives evaluation information from the evaluation server 200 via the network N1. Thereby, the user of the user terminal 300 can grasp vehicle skidability in an evaluation section.

### Functional Configuration

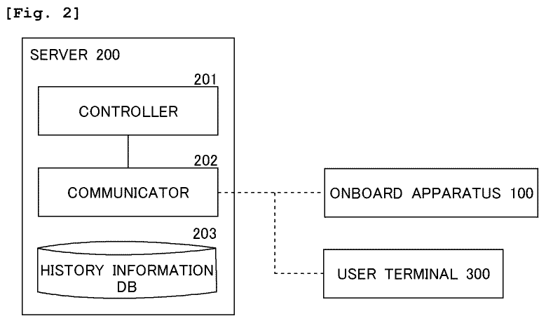

Next, the functional configuration of the evaluation server 200 constituting the evaluation system 1 will be described based on FIG. 2. FIG. 2 is a block diagram schematically illustrating an example of the functional configuration of the evaluation server 200. The evaluation server 200 includes a controller 201, a communicator 202, and a history information database 203 (a history information DB 203).

The controller 201 has a function of performing arithmetic processing for controlling the evaluation server 200. The controller 201 can be realized by the processor 210 in the evaluation server 200. The communicator 202 has a function of connecting the evaluation server 200 to the network N1. The communicator 202 can be realized by the communication I/F 240 in the evaluation server 200. The controller 201 receives probe information from the onboard apparatus 100 via the communicator 202. The controller 201 updates history information held in the history information DB 203 according to the probe information received from the onboard apparatus 100.

The history information DB 203 has a function of holding the history information. The history information is information indicating a history of wheel velocity differences at the time of the vehicle traveling on roads. Here, the wheel velocity difference is a value obtained by subtracting the minimum wheel velocity of the vehicle from the maximum wheel velocity. Note that, when the vehicle 10 is a two-wheel drive vehicle, and the wheel velocities of non-driven wheels and driven wheels are the same, the wheel velocity difference may be determined by the absolute value of a difference between the wheel velocity of the non-driven wheels and the wheel velocity of the drive wheels.

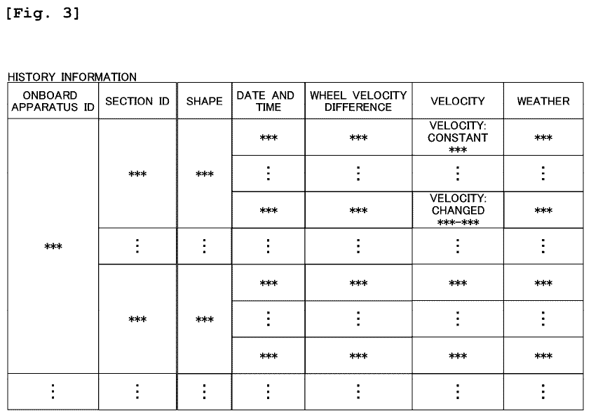

FIG. 3 is a diagram illustrating an example of a table configuration of the history information held in the history information DB 203. As illustrated in FIG. 3, the history information includes onboard apparatus ID, section ID, shape, date and time, wheel velocity difference, velocity, and weather fields.

In each onboard apparatus ID field, an identifier for identifying an onboard apparatus that has transmitted probe information (an onboard apparatus ID) is stored. In each section ID field, an identifier for identifying a road section (a section ID) is stored. In the section ID fields, section ID's of sections including vehicle skidability evaluation sections on roads are stored. In each shape field, information indicating a road shape of a section with a corresponding section ID is stored. Specifically, in each shape field, information indicating a curve shape in a section with a corresponding section ID is stored. As the information indicating a curve shape, for example, information indicating a curve curvature (a curvature radius) is stored. When a section with a corresponding section ID is a straight line, information indicating that the section is a straight line is stored in the shape field. Furthermore, in each shape field, information indicating a slope of a section with a corresponding section ID is stored.

In each date and time field, information indicating a date and time when a vehicle mounted with an onboard apparatus with a corresponding onboard apparatus ID traveled in a section with a corresponding section ID is stored. In each wheel velocity difference field, information indicating a wheel velocity difference at the time of the vehicle traveling in a section with a corresponding section ID is stored. The controller 201 calculates a wheel velocity difference at the time of traveling in a section with a corresponding section ID, according to the position of the vehicle and the wheel velocity of each wheel of the vehicle in the probe information. That is, the controller 201 refers to the probe information and, when judging that the vehicle is traveling in a section with a corresponding section ID, calculates a value obtained by subtracting the minimum wheel velocity of the vehicle from the maximum wheel velocity, the wheel velocity difference. Then, the controller 201 stores the calculated value of the wheel velocity difference into the wheel velocity difference field.

In each velocity field, information about the velocity of the vehicle at the time of traveling in a section with a corresponding section ID is stored. Specifically, in each velocity field, information indicating whether the velocity of the vehicle at the time of traveling in a section with a corresponding section ID is constant or not is stored. The controller 201 refers to the velocity of the vehicle in the probe information to determine whether the velocity of the vehicle at the time of traveling in a section with a corresponding section ID is constant or not. Then, the controller 201 stores a determination result into the velocity field. Here, when the velocity of the vehicle is constant, information “velocity: constant” is stored into the velocity field. When the velocity of the vehicle is not constant, information “velocity: changed” is stored into the velocity field.

Furthermore, in each velocity field, information indicating a velocity at the time of the vehicle traveling in a section with a corresponding section ID is stored. When the velocity at the time of the vehicle traveling in a section with a corresponding section ID is constant, information indicating constant velocity is stored. When the velocity at the time of the vehicle traveling in a section with a corresponding section ID changes, information indicating a range of the changed velocity is stored.

In each weather field, information indicating weather on a date and time of the vehicle traveling in a section with a corresponding section ID is stored. In each weather field, for example, information about a precipitation amount, a snowfall amount, temperature, or with/without road freezing, and the like is stored. The controller 201 acquires weather on the date and time of the vehicle traveling in a section with a corresponding section ID, from a server apparatus or the like that manages weather information via the communicator 202 and stores the weather into the weather field.

The controller 201 refers to the probe information received from the onboard apparatus 100 to determine whether the vehicle 10 is traveling in an evaluation section or not in real time. If the vehicle 10 is traveling in an evaluation section, the controller 201 evaluates vehicle skidability in the evaluation section according to the probe information about the vehicle 10.

At this time, if the vehicle is traveling on a skiddy road, the wheels tend to easily spin. Therefore, it is assumed that, when the vehicle is traveling on a skiddy road, the wheel velocity difference becomes large. Furthermore, there may be a case where a road is more skiddy than usual as road surface conditions change due to precipitation, snow fall, freezing, or the like on the road. Therefore, the controller 201 evaluates vehicle skidability due to influence of change in road surface conditions, using the wheel velocity difference.

Specifically, the controller 201 refers to the history information held in the history information DB 203 and acquires a wheel velocity difference when the vehicle 10 traveled in the evaluation section on a reference date and time as a reference value. Here, the controller 201 identifies a date and time when the amount of precipitation is 0, the amount of snowfall is 0, and the road is not frozen, as the reference date and time. Note that, as for whether the road is frozen or not, it may be determined by whether the temperature is equal to or above a predetermined temperature or not. Here, the predetermined temperature is set in advance as temperature at which the road is predicted to be frozen.

When there are a plurality of dates and time corresponding to the reference date and time, the controller 201 may acquire an average value of the wheel velocity differences on the plurality of reference dates and time as the reference value. It is assumed that, even in the case of traveling in the same evaluation section, the wheel velocity difference may be different when the velocity of the vehicle 10 is high and when the velocity of the vehicle 10 is low. Therefore, the controller 201 refers to the velocity fields in the history information, and acquires a wheel velocity difference at the time of traveling with the same velocity as the current velocity of the vehicle 10 or within a predetermined range from the current velocity, as the reference value.

From the wheel velocity of each wheel in the probe information about the vehicle 10, the controller 201 calculates a wheel velocity difference (a value obtained by subtracting the minimum wheel velocity from the maximum wheel velocity) as an actual measurement value. Here, a value obtained by subtracting the reference value from the actual measurement value is a difference between the wheel velocity difference at the time of the vehicle 10 traveling in the evaluation section and the wheel velocity difference at the time of the vehicle 10 traveling in the evaluation value on the reference date and time (a normal wheel velocity difference when freezing or the like has not occurred). Therefore, the value obtained by subtracting the reference value from the actual measurement value is a wheel velocity difference that has occurred due to influence of change in road surface conditions. Therefore, the controller 201 calculates the value obtained by subtracting the reference value from the actual measurement value as an evaluation parameter. Here, the evaluation parameter is a value that correlates with vehicle skidability due to influence of change in road surface conditions. Note that, as a method for calculating the evaluation parameter, a method other than the method of subtracting the reference value from the actual measurement value can be adopted.

The controller 201 evaluates vehicle skidability in the evaluation section according to the calculated evaluation parameter. Here, vehicle skidability evaluation values with which evaluation parameters are associated, respectively, are set. The controller 201 decides an evaluation value with which the calculated evaluation parameter is associated, as an evaluation result. Then, the controller 201 outputs evaluation information that includes the evaluation value, to the user terminal 300 via the communicator 202. Furthermore, the evaluation information may include a vehicle skidability evaluation value according to the actual measurement value (a vehicle skidability evaluation value that includes influence of change in road surface conditions).

In the present embodiment, a plurality of vehicles 10 are targeted by collection of probe information. In this case, there may be a case where, after one vehicle 10 travels in an evaluation section, another vehicle 10 travels in the evaluation section. In this case, the controller 201 updates the evaluation value with an evaluation value at the time of another vehicle 10 traveling in the evaluation section. The controller 201 may calculate an evaluation value corresponding to probe information about another vehicle 10 that has traveled in the evaluation section, after elapse of a predetermined time after the one vehicle 10 traveled in the evaluation section. Then, the controller 201 outputs evaluation information that includes the updated evaluation value to the user terminal 300.

### Flowchart

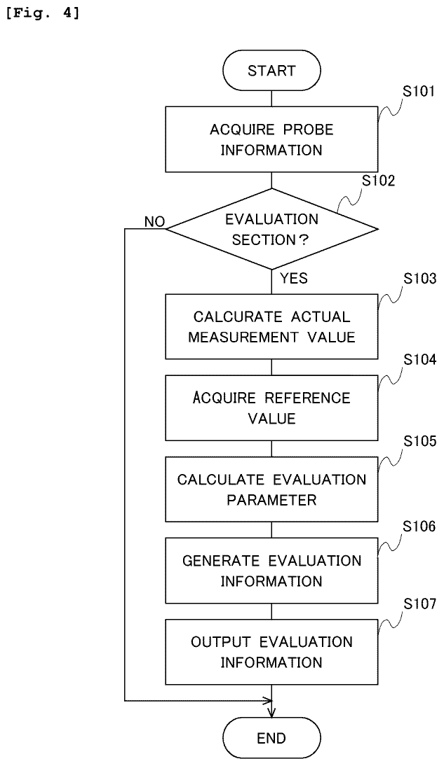

Next, a description will be made on a process executed by the controller 201 in the evaluation server 200, in the evaluation system 1 based on FIG. 4. FIG. 4 is a flowchart of the process executed by the controller 201 in the evaluation server 200. The process is a process for outputting evaluation information. The process illustrated in FIG. 4 is repeatedly executed at predetermined intervals.

In the process illustrated in FIG. 4, probe information received from the onboard apparatus 100 is acquired first at S101. Next, at S102, it is determined whether the vehicle 10 is traveling in an evaluation section or not. If a negative determination is made at S102, it is not possible to evaluate vehicle skidability in an evaluation section because the vehicle 10 is not traveling in an evaluation section. Therefore, the process illustrated in FIG. 4 is ended once.

If a positive determination is made at S102, an actual measurement value is calculated at S103 because the vehicle 10 is traveling in an evaluation section. That is, the controller 201 calculates a wheel velocity difference according to the wheel velocity of each wheel of the vehicle 10 in the probe information. At S104, the history information held in the history information DB 203 is referred to, and a wheel velocity difference when the vehicle 10 traveled in the evaluation section on a reference date and time is acquired as a reference value. Here, the controller 201 may refer to the history information to calculate the reference value each time or may acquire a reference value calculated with reference to the history information and held in a database in advance.

Next, at S105, an evaluation parameter according to the actual measurement value and the reference value is calculated. That is, the evaluation parameter is outputted by subtracting the wheel velocity difference which is the reference value from the wheel velocity difference, which is the actual measurement value. Next, at S106, evaluation information is generated according to the evaluation parameter. Next, at S107, the evaluation information is outputted to the user terminal 300. Then, the process illustrated in FIG. 4 is ended once.

As described above, an evaluation parameter is calculated by the evaluation system 1. Then, vehicle skidability in an evaluation section is evaluated by the information processing apparatus according to the evaluation parameter. Thereby, it is possible to evaluate vehicle skidability due to influence of change in road surface conditions. In this way, it becomes possible to evaluate vehicle skidability on a road in more detail.

### Modification 1

In the present embodiment, the reference value is a wheel velocity difference when the vehicle 10 traveled in an evaluation section on a reference date and time. As the reference value, however, other values can be adopted. In the present modification, the reference value is a value calculated according to a formula for predicting a wheel velocity difference caused due to a curve shape.

The controller 201 acquires a curve shape in an evaluation section. In the present modification, the controller 201 acquires a curve curvature (the curvature radius) as the curve shape in an evaluation section. The controller 201 refers to the shape fields in the history information held in the history information DB 203 to acquire information the indicating the curve shape in evaluation section. Note that the controller 201 may acquire the curve shape in the evaluation section from an external server via the communicator 202.

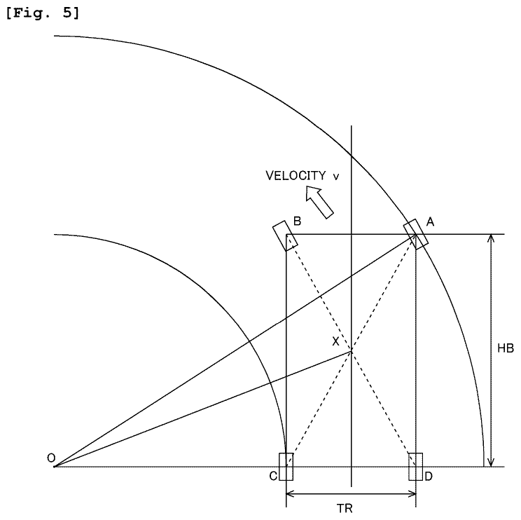

FIG. 5 is a diagram illustrating an inner wheel difference when the vehicle 10 is traveling on a curve. In the example illustrated in FIG. 5, a case where the vehicle 10 is traveling on a left curve is illustrated. The positions of the four wheels of the vehicle 10 (the centers of surfaces in contact with the ground) are assumed as points A, B, C, and D, respectively. Here, the points A, B, C, and D are located at positions of the right front, left front, left rear, and right rear wheels of the vehicle 10, respectively. Furthermore, the center (the centroid) of the vehicle 10 is assumed as a point X. The wheelbase of the vehicle 10 is indicated by HB, and the tread of the vehicle 10 is indicated by TR. The center of the curvature of the curve is assumed as a point O.

When the vehicle 10 travels on the left curve, the wheel velocity of the wheel located at the point A that is the farthest from the point O is the highest. In this case, the wheel velocity of the wheel located at the point C that is nearest to the point O is the lowest. By using the Pythagorean theorem, the distance of OA and the distance of OC are expressed by (Formula 1) and (Formula 2) below, respectively.

$$OA = \sqrt{{( \sqrt{{OX}^{2} - \frac{1}{4} H {B}^{2}} + \frac{1}{2} T R )}^{2} + H {B}^{2}} \qquad ( Formula 1 )$$

$$OC = \sqrt{{OX}^{2} - \frac{1}{4} H {B}^{2}} - \frac{1}{2} TR \qquad ( Formula 2 )$$

The radius of the wheels is indicated by r, and the velocity of the vehicle 10 is indicated by v (the velocity of the point X). In this case, time required for the vehicle 10 to travel around a circle with a radius OX once is 2πOX/v. Meanwhile, when the vehicle 10 travels around the circle with the radius of OX, the wheel at the point A moves by 2πOA. Therefore, the velocity of the wheel at the point A is (OA/OX)·v which is obtained by dividing 2πOA by 2πOX/v. Therefore, the number of rotations of the wheel at the point A is (OA/OX)·v/2πr which is obtained by dividing (OA/OX)·v by 2πr which is the circumference length of the wheel. Therefore, the wheel velocity (the angular velocity) at the point A is (OA/OX)·v/r. Similarly, the wheel velocity of the wheel at the point C is (OC/OX)·v/r.

Therefore, a difference between the wheel velocity of the wheel at the point A and the wheel velocity of the wheel at the point C (a wheel velocity difference) is {(OA—OC)/OX}·v/r. Therefore, when the vehicle 10 is traveling on the left curve illustrated in FIG. 5, the wheel velocity difference is indicated by (Formula 3) below using OX, HB, TR, v, and r.

$$\frac{\begin{matrix}\sqrt{{( \sqrt{{OX}^{2} - \frac{1}{4} {HB}^{2}} + \frac{1}{2} TR )}^{2} + {HB}^{2}} - \\ \sqrt{{OX}^{2} - \frac{1}{4} {HB}^{2}} + \frac{1}{2} TR\end{matrix}}{OX} \cdot \frac{v}{r} \qquad ( Formula 3 )$$

Here, OX is the curvature radius of the left curve. Furthermore, HB, TR, and r are values unique to the vehicle 10, and v can be acquired from probe information. Therefore, the controller 201 by acquiring the curvature of the curve (OX), the wheel base (HB), tread (TR), and velocity (v) of the vehicle 10, and the radius (r) of the wheels, and substituting them into (Formula 3), the controller 201 can calculate a wheel velocity difference predicted to occur when the vehicle 10 is traveling on the left curve.

When the vehicle 10 is traveling on a right curve, the wheel velocity of the wheel located at the point B that is the farthest from the point O (the center of the curvature of the right curve) is higher than the other wheels. In this case, the wheel velocity of the wheel located at the point D that is nearest to the point O is the lowest. Furthermore, between the case of the vehicle 10 traveling on the left curve and the case of traveling the right curve, there is symmetry. Therefore, OB in the case of traveling on the right curve is the same value as the right-hand side of (Formula 3). Furthermore, OD in the case of traveling on the right curve is the same value as the right-hand side of (Formula 4). Furthermore, since OX is the curvature radius of the right curve, a wheel velocity difference predicted to occur when the vehicle 10 is traveling on the right curve can be calculated by (Formula 3).

The controller 201 calculates an evaluation parameter, with a wheel velocity difference predicted to occur when the vehicle 10 is traveling a curve as a reference value. Thereby, the controller 201 can calculate a wheel velocity difference from which a wheel velocity difference caused by a curve shape is excluded. Therefore, the controller 201 can evaluate vehicle skidability due to influence of change in road surface conditions, excluding influence by a road shape (a curve shape). In this case also, it becomes possible to evaluate vehicle skidability on a road in more detail.

### Modification 2

In the state of a large torque being applied to wheels, a rotation force applied to the wheels is large in comparison with the state of a small torque being applied to the wheels. Therefore, in the state of a large torque being applied to wheels, a wheel velocity difference tends to be large in comparison with the state of a small torque being applied to the wheels.

When a slope in an evaluation section is large, a normal force acting on each wheel of the vehicle 10 is small in comparison with a case where the slope is small. Therefore, a frictional force acting on the vehicle 10 is small. Therefore, when a slope in an evaluation section is large, a wheel velocity difference that occurs accompanying occurrence of torque tends to be large in comparison with the case where the slope is small.

Therefore, the controller 201 calculates an evaluation parameter according to a wheel velocity difference predicted to occur in a state of torque being applied to the wheels (a predicted wheel velocity difference) and a slope in an evaluation section. Specifically, the controller 201 acquires an accelerator operation amount or brake operation amount of the vehicle 10 from probe information. The controller 201 acquires association among the slope, the accelerator operation amount or brake operation amount, and the predicted wheel velocity difference (which may be hereinafter referred to simply as “the association”). The controller 201 acquires a reference value according to the association. Then, the controller 201 calculates an evaluation parameter according to the acquired reference value.

Here, the controller 201 decides the association according to probe information received in the past. At this time, the controller 201 decides the association according to data of an accelerator operation amount, a brake operation amount, and a wheel velocity difference at the time of traveling in a section with each slope on the reference date and time. The association may be determined in advance from a correlation obtained by experiments. In this case, the association is determined from an experimental result at the time when the precipitation amount was 0, the snowfall amount was 0, and the road was dry.

Thereby, it is possible to evaluate vehicle skidability due to influence of change in road surface conditions, excluding influence by the traveling state (the accelerator operation amount or the brake operation amount) of the vehicle. In this case also, it becomes possible to evaluate vehicle skidability on a road in more detail.

When torque is applied to the wheels of the vehicle 10, it is assumed that longitudinal acceleration of the vehicle 10 has occurred. Therefore, the controller 201 may acquire, instead of the accelerator operation amount or the brake operation amount, the longitudinal acceleration applied to the vehicle 10 from the probe information. Then, the controller 201 acquires a reference value according to association among a slope, a longitudinal acceleration, and a predicted wheel velocity difference stored in advance. In this case also, it becomes possible to evaluate vehicle skidability on a road in more detail.

Note that there may be a case where the vehicle 10 travels in an evaluation section with a slope and a curve shape, while changing the accelerator operation amount and the like. In this case, the controller 201 may calculate an evaluation parameter, with the sum of a reference value according to the slope in the evaluation section and the torque of the vehicle 10 and a reference value according to the curve shape in the evaluation section as a new reference value. Thereby, it is possible to evaluate vehicle skidability due to influence of change in road surface conditions from which a wheel velocity difference due to the vehicle 10 traveling in a section with a slope and a curve shape, applying torque to the wheels is excluded.

### Modification 3

There may be a case where a wheel velocity difference occurs by the diameter of a wheel of the vehicle 10 being changed. For example, there may be a case where the diameter of one wheel has become smaller than the diameter of the other wheels. In this case, since the wheel velocity of the wheel with the small diameter becomes larger than the wheel velocity of the other wheels, a wheel velocity difference occurs.

Here, the diameter of the wheels of the vehicle 10 changes according to a cargo amount on the vehicle 10. Furthermore, when a cargo is unevenly placed on the vehicle 10, a load is applied to a particular wheel. By the tire of the particular wheel being compressed thereby, the diameter of the wheel of the vehicle 10 is reduced. Furthermore, the diameter of each wheel of the vehicle 10 is reduced according to the air pressure of the tire of the wheel. Furthermore, the diameter of each wheel of the vehicle 10 is reduced by the tire of the wheel being worn out.

When the vehicle 10 is traveling straight, the wheel velocity difference due to a curve as described above does not occur. When the vehicle 10 is traveling at a constant velocity, the wheel velocity difference due to torque as described above does not occur. Therefore, it is assumed that a wheel velocity difference in the state of the vehicle 10 traveling straight at a constant velocity is a wheel velocity difference caused by the diameter of a wheel of the vehicle 10 having changed. Therefore, the controller 201 refers to the history information held in the history information DB 203 and acquires a wheel velocity difference in the state of the vehicle 10 traveling straight at a constant velocity as a reference value. Specifically, the controller 201 refers to the shape fields and the velocity fields in the history information, and acquires a wheel velocity difference when the vehicle 10 traveled in a section with a section ID for which information that the road shape is straight line and information of “velocity: constant” are stored.

At this time, in the history information, there may be a case where a plurality of pieces of data of having traveled in a section with a section ID for which the information that the road shape is straight line and the information of “velocity: constant” are stored. In this case, the controller 201 acquires a wheel velocity difference at the time of the most recent travel, as a reference value. Thereby, it is possible to acquire a wheel velocity difference at the time of traveling in a state of wheels with a diameter that is the closest to the current diameter of the wheel of vehicle 10, as a reference value.

Here, the higher the velocity of the vehicle 10 is, the higher the wheel velocity is. Therefore, when the velocity of the vehicle 10 is high, it is assumed that a wheel velocity difference between the wheel with a reduced diameter and the other wheels is larger in comparison with the case where the velocity of the vehicle 10 is low. Therefore, the controller 201 acquires a wheel velocity difference at the time of traveling straight with the same velocity as the velocity at the time of the vehicle 10 traveling in the evaluation section (a constant velocity) or a velocity within a predetermined range from the velocity, as a reference value.

The controller 201 calculates an evaluation parameter by subtracting the reference value from an actual measurement value. Thereby, it is possible to evaluate vehicle skidability in an evaluation section, excluding influence of a wheel velocity difference caused by the diameter of a wheel of the vehicle 10 having changed.

Note that there may be a case where the diameter of the wheels of the vehicle 10 is different from that when the vehicle 10 traveled in the evaluation section in the past. Therefore, the controller 201 may calculate the evaluation parameter, with the sum of a reference value when the vehicle 10 traveled in the evaluation section on a reference date and time and a reference value at the time of traveling straight with the same velocity as velocity at the time of the vehicle 10 traveling in the evaluation section (a constant velocity) as a new reference value. Thereby, it is possible to further exclude influence by the diameter of the wheels of the vehicle 10 being different from when the vehicle 10 traveled in the evaluation section in the past to evaluate vehicle skidability in the evaluation section.

Furthermore, there may be a case where the vehicle 10 travels in an evaluation section with a curve shape in a state of the diameter of the wheels of the vehicle 10 being different. Therefore, the controller 201 may calculate an evaluation parameter, with the sum of a reference value calculated according to the formula for predicting a wheel velocity difference caused due to a curve shape and a reference value of traveling straight with the same velocity as the velocity at the time of the vehicle 10 traveling in the evaluation section (a constant velocity) as a new reference value. Thereby, it is possible to exclude influence by the vehicle 10 traveling in the evaluation section with a curve shape in a state of the diameter of a wheel being different to evaluate vehicle skidability in an evaluation section.

Furthermore, there may be a case where the vehicle 10 travels in an evaluation section with a slope in a state of the diameter of the wheels of the vehicle 10 being different. Therefore, the controller 201 may calculate an evaluation parameter, with the sum of a reference value according to the slope of the evaluation section and the torque of the vehicle 10 and a reference value of traveling straight with the same velocity as the velocity at the time of the vehicle 10 traveling in the evaluation section (a constant velocity) as a new reference value. Thereby, it is possible for the vehicle 10 to exclude influence of traveling in the evaluation section with a slope in a state of the torque being applied to the wheels of the vehicle 10 with a different diameter to evaluate vehicle skidability in the evaluation section.

### Modification 4

In the present embodiment, a result information output destination is the user terminal 300. The result information output destination, however, is not necessarily required to be the user terminal 300. The result information output destination may be a terminal used by a road manager. Furthermore, the result information output destination may be, for example, a server apparatus that distributes a vehicle skidability evaluation result to a user.

### Other Embodiments

The embodiment described above is a mere example, and the present disclosure can be appropriately changed and practiced within a range not departing from the spirit thereof. Furthermore, the processes and methods described in the present disclosure can be freely combined and implemented as far as technical inconsistencies do not occur.

Furthermore, a process described as being performed by one apparatus may be shared and executed by a plurality of apparatuses. Or alternatively, processes described as being performed by different apparatuses may be executed by one apparatus. In a computer system, in what hardware configuration (a server configuration) each function is realized can be flexibly changed.

The present disclosure can be realized by supplying a computer program implemented with the functions described in the above embodiment to a computer, and one or more processors of the computer reading out and executing the program. Such a computer program may be provided for the computer by a non-transitory computer-readable storage medium connectable to the system bus of the computer or may be provided for the computer via a network. As the non-transitory computer-readable storage medium, for example, any type of disk such as a magnetic disk (a floppy (registered trademark) disk, a hard disk drive (HDD), or the like) or an optical disc (a CD-ROM, a DVD disc, a Blu-ray disc, or the like), and any type of medium that is appropriate for storing electronic commands like a read-only memory (ROM), a random access memory (RAM), an EPROM, an EEPROM, a magnetic card, a flash memory, or an optical card are included.

What is claimed is:

1. An information processing apparatus comprising a controller, the controller being configured to execute:
receiving probe information in real time, the probe information including a position of a target vehicle acquired by a GPS apparatus mounted on the target vehicle and a wheel velocity of each wheel sensed by a wheel velocity sensor of the target vehicle;
referring to the probe information to determine whether the target vehicle is traveling in a vehicle skidability evaluation section or not in real time;
calculating an actual measurement value of a wheel velocity difference of the target vehicle according to the probe information when the target vehicle is traveling in the evaluation section;
acquiring a reference value for the wheel velocity difference in the evaluation section;
calculating an evaluation parameter using the actual measurement value and the reference value;
evaluating vehicle skidability due to influence of change in road surface conditions in the evaluation section, according to the evaluation parameter; and
outputting result information about the evaluation to an external apparatus.

2. An information processing apparatus comprising a controller, the controller being configured to execute:
calculating an actual measurement value of a wheel velocity difference of a target vehicle according to probe information including a wheel velocity of each wheel of the target vehicle in a vehicle skidability evaluation section;
acquiring a reference value for the wheel velocity difference of the target vehicle in the evaluation section;
calculating an evaluation parameter using the actual measurement value and the reference value;
evaluating vehicle skidability due to influence of change in road surface conditions in the evaluation section, according to the evaluation parameter; and
outputting result information about the evaluation.

3. The information processing apparatus according to claim 2, wherein the acquiring of the reference value comprises acquiring a wheel velocity difference when the target vehicle travels in the evaluation section at reference time.

4. The information processing apparatus according to claim 2, wherein
the acquiring of the reference value comprises:
acquiring a curve shape in the evaluation section; and
calculating the reference value according to a formula for predicting a wheel velocity difference caused due to the curve shape.

5. The information processing apparatus according to claim 2, wherein
the probe information includes at least one of an accelerator operation amount, a brake operation amount, and longitudinal acceleration of the target vehicle in the evaluation section; and
the acquiring of the reference value comprises acquiring at least one of the accelerator operation amount, the brake operation amount, and the longitudinal acceleration of the target vehicle, and a predicted value for a wheel velocity difference caused by a slope in the evaluation section.

6. The information processing apparatus according to claim 4, wherein
the probe information includes at least one of an accelerator operation amount, a brake operation amount, and longitudinal acceleration of the target vehicle in the evaluation section; and
the acquiring of the reference value comprises acquiring at least one of the accelerator operation amount, the brake operation amount, and the longitudinal acceleration of the target vehicle, and a predicted value for a wheel velocity difference caused by a slope in the evaluation section.

7. The information processing apparatus according to claim 2, wherein the acquiring of the reference value comprises acquiring a wheel velocity difference in a state of the target vehicle traveling straight and at a constant velocity.

8. The information processing apparatus according to claim 3, wherein the acquiring of the reference value comprises acquiring a wheel velocity difference in a state of the target vehicle traveling straight and at a constant velocity.

9. The information processing apparatus according to claim 4, wherein the acquiring of the reference value comprises acquiring a wheel velocity difference in a state of the target vehicle traveling straight and at a constant velocity.
